(19) United States
(12) Patent Application Publication
(10) Pub. No.: US 2004/0217556 A1
(43) Pub. Date: Nov. 4, 2004

(54) Sealing device

(76) Inventors: Thomas Klenk, Eppelheim (DE); Michael Kessler, Seevetal (DE)

Correspondence Address: HARNESS, DICKEY & PIERCE, P.L.C., P.O. BOX 828, BLOOMFIELD HILLS, MI, 48303, US

(21) Appl. No.: 10/834,819

(22) Filed: Apr. 28, 2004

(30) Foreign Application Priority Data
Apr. 30, 2003 (DE) 10319753.2

(51) Int. Cl. B32B 5/26

(52) U.S. Cl. 277/650

(57) ABSTRACT

A sealing device, particularly for machine elements that move axially toward one another, with at least one sealing collar having a V-shaped cross-section, characterized in that the sealing collar consists of a PTFE nonwoven material.

### CROSS-REFERENCE TO RELATED APPLICATIONS

This application claims the benefit of German Patent Application 10,319,753.2, filed Apr. 30, 2003. The disclosure of the above application is incorporated herein by reference.

### FIELD OF THE INVENTION

The present invention relates to a sealing device and a process for fabricating a sealing device.

### DESCRIPTION OF THE BACKGROUND ART

DE 199 06 733 C2 discloses a sealing device comprising a number of annular and, in axial cross-section, V-shaped sealing elements generally referred to as sealing collars. The sealing devices are used particularly for sealing machine elements that move axially relative to each other. To reinforce the sealing action, a side with an open profile faces the medium that needs to be sealed off.

For the afore-mentioned sealing device, elastomers such as polyurethane (PUR), nitrile rubber (NBR), or fluorinated rubber (FKM) are used.

The drawback of these elastomeric materials, however, is that their coefficient of friction is higher than that of, for example, PTFE. Moreover, the above elastomers have a tendency to set, and at higher pressures there is the risk of gap extrusion. The higher friction results in increased abrasion and thus increased wear.

PTFE, on the other hand, has the highest chemical resistance to nearly all media that need to be sealed off over a very wide temperature range and a very low coefficient of friction so that stick-slip is prevented. PTFE, however, has a pronounced cold-flow tendency and thus presents a gap extrusion risk.

To counteract the cold-flow tendency of PTFE, it is known to impregnate fabric webs with a PTFE dispersion. The finished sealing collar then consists of several layers of PTFE-coated fabric. The drawback of this approach, however, is that PTFE is present only as a layer on the surface of the fabric, and does not completely penetrate the fabric. This results in a layered structure of fabric and PTFE leading to varying friction conditions and increased wear because the frictional properties of the fabric are much worse than those of PTFE.

### SUMMARY OF THE INVENTION

The object of the invention is to provide a sealing device with very good frictional properties to minimize wear and the risk of gap extrusion.

According to the present invention, a sealing device includes sealing collars made of a PTFE nonwoven material. PTFE has a low coefficient of friction, can be used for a wide range of temperatures and it is resistant to most media that need to be sealed off. To counteract the cold-flow tendency and gap extrusion, the PTFE is incorporated into a nonwoven fabric. Needling or water-jet strengthening then imparts to the nonwoven fabric a tridimensional, open, and porous structure which, due to mechanical bonding, is stable at high temperatures. Because of the open, porous structure, impregnation of the PTFE can result in a PTFE content of up to 99%. The open structure allows complete penetration of the nonwoven fabric, which makes the lubricating properties of PTFE available also within the entire structure of nonwoven fabric, and not only on the surfaces of the nonwoven fabric. Further, gap extrusion of PTFE is prevented by an interlocking of the PTFE in the matrix of the nonwoven fabric.

In a first embodiment of the present invention, the sealing collars consist of a band of PTFE nonwoven fabric, radially wound upon itself. In this configuration of a nonwoven web cut to form a band, good internal compression of the starting material and, at the same time, good mutual interlocking of the impregnated nonwoven bands is achieved during the compression process.

In another embodiment, the sealing collars consist of superposed disks of a PTFE nonwoven fabric. The superposition permits the use of thin nonwoven disks that ensure complete penetration of PTFE.

In another embodiment, the sealing collar consists of a nonwoven web joined in tubular fashion and rolled up to form a ring.

The nonwoven webs have a thickness of less than 4 mm and preferably from 0.5 to 2 mm. At these thicknesses, a short residence time in the impregnation bath allows complete penetration of PTFE into the nonwoven fabric.

Preferably, the PTFE content amounts to 50 to 99% of the PTFE nonwoven fabric, corresponding to the highest degree of saturation of the nonwoven fabric with PTFE.

The length of the fibers in the nonwoven fabric preferably amount to 3 to 100 mm. Fibers longer that 3 mm effectively counteract the cold-flow tendency of PTFE and thus gap extrusion.

Advantageously, the weight per unit area of the nonwoven fabric before PTFE impregnation is from 20 to 800 g/m².

The fibers of the nonwoven fabric preferably consist of aramide. Aramide fibers are particularly well suited for use at high temperatures.

In one embodiment, the nonwoven fabric consists of a fiber blend containing at least one of the following: glass fibers, aramide fibers, polyamide fibers, polybenzimidazole fibers, basalt fibers, carbon fibers, graphite fibers, or polyester.

In an advantageous embodiment, the internal surfaces of the sealing collar are inclined to each other at an angle from 45 to 120°, and preferably from 60 to 90°. This inclination allows maximum pressing of the sealing collar against the surface to be sealed because the pressure of the medium increases the pressing force.

To produce a sealing collar, a nonwoven web is impregnated with PTFE and then dried in a continuous oven at 30 to 300° C. The drying in a continuous oven prevents accumulation of the impregnant. From the PTFE-impregnated nonwoven web, a blank is prepared and then compressed in a pressing mold at a pressure from 5 to 100 MPa to produce a V-shaped sealing collar. This pressure results in very good internal compression of the material and good bonding of the nonwoven webs. The sealing collar is finished by a subsequent sintering treatment at a temperature from 340 to 390° C. for a period of 10 to 60 minutes. The sintering firms up the sealing collar, thus further reducing the gap extrusion tendency.

In another embodiment, the blank is produced by radially rolling up at least two plies of a nonwoven PTFE band.

In yet another embodiment, the blank is produced by superposing on one another, ring-shaped disks cut out of the PTFE nonwoven.

In another embodiment, the blank is produced by rolling into a ring a PTFE-impregnated nonwoven web stitched together to form a tube.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top view of a blank of a sealing collar obtained from a nonwoven band radially wound about itself in accordance with a principle of the present invention;

FIG. 2 is a cross-sectional view of a blank consisting of superposed nonwoven disks according to a principle of the present invention;

FIG. 3 is a cross-sectional view of a blank obtained by rolling up a tube of a nonwoven fabric according to a principle of the present invention;

FIG. 4 is a cross-sectional view of a compression device with an inserted blank according to a principle of the present invention; and

FIG. 5 shows a sealing collar according to a principle of the present invention in cross-section.

### DETAILED DESCRIPTION OF THE PREFERRED EMBODIMENTS

The following description of the preferred embodiment(s) is merely exemplary in nature and is in no way intended to limit the invention, its application, or uses.

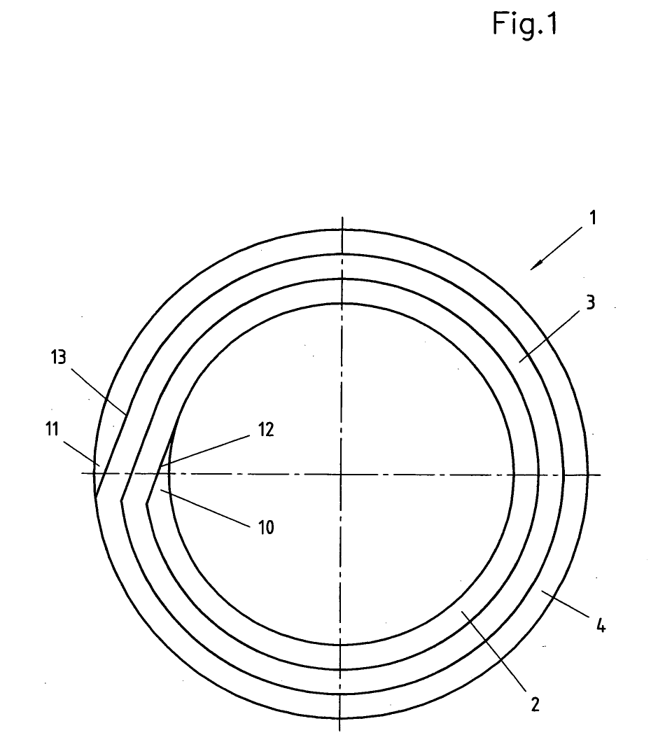

FIG. 1 shows a top view of a blank 1 which will later serve as sealing collar. The blank 1 consists of three plies 2, 3 and 4 of a PTFE-impregnated nonwoven band radially wound about themselves. The beginning 10 of the winding of first ply 2, and the end 11 of the winding of the last ply 4 of the nonwoven band lie with their cut edges 12 and 13 over one another. Cutting edges 12 and 13 are provided with outward oriented bevels.

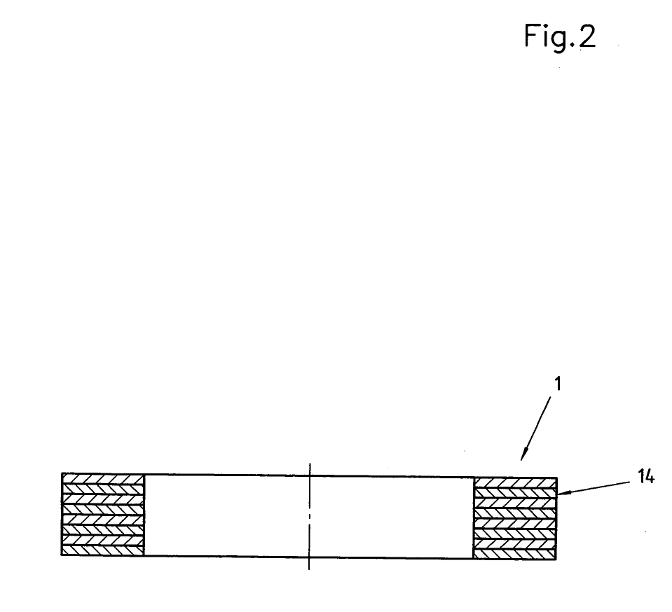

FIG. 2 shows a blank 1 in cross-section. Blank 1 consists of a number, in this embodiment eight, disks 14 superposed on one another which were cut out from a PTFE-impregnated nonwoven web.

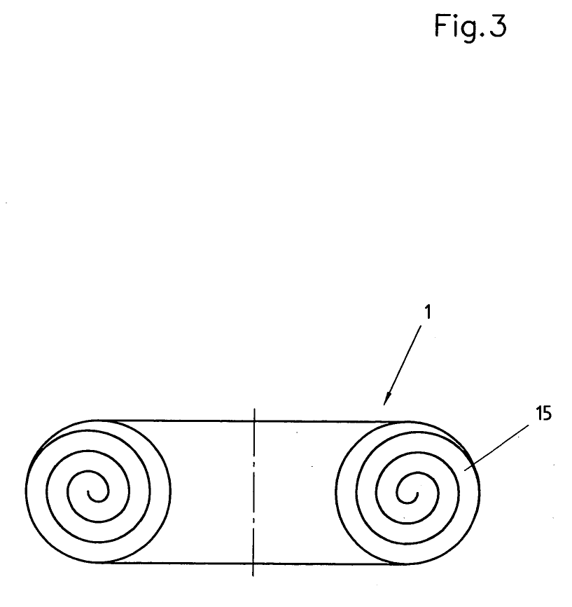

FIG. 3 shows a blank 1 in cross-section. In this embodiment, blank 1 consists of a nonwoven web 15 stitched on a mandrel to form a tubular shape which is then rolled up to give blank 1 a spiral-shaped cross-section.

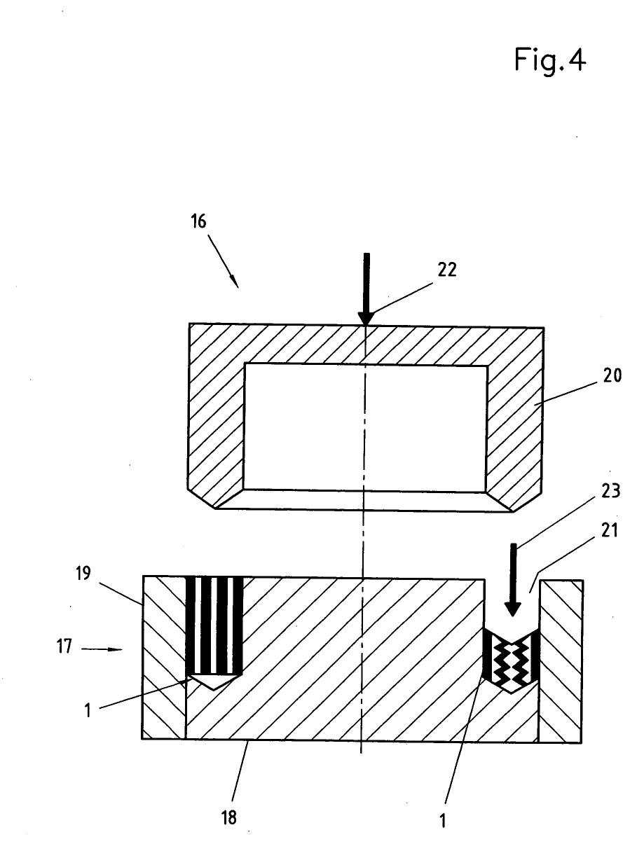

FIG. 4 shows a compression device 16 in which the impregnated, prepared blank 1 is compressed. Compression device 16 consists of a die block 17 with core 18 and jacket 19, as well as punch 20. In the present embodiment, the blank 1 rolled up as in FIG. 1 is inserted into a space 21, between core 18 and jacket 19, as shown on the left side of the figure. The punch 20 is then pressed axially into the space 21 as indicated by arrows 22 and 23. As a result, the blank 1 is compressed, as shown on the right side of the figure. By this compression, the blank 1 is given the characteristic V-shape. After the compression step, the blank 1 is removed from the compression device 17 and finished by a subsequent heat treatment.

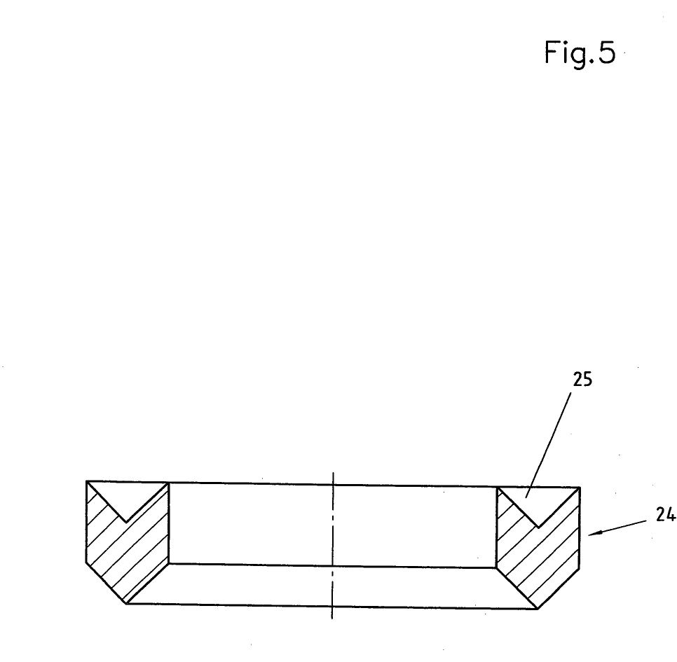

FIG. 5 shows the finished sealing collar 24 in which the internal surfaces 25 are inclined relative to each other at a 90° angle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A sealing device for machine elements that move axially relative to one another, comprising at least one sealing collar with a V-shaped cross-section, wherein the sealing collar comprises a PTFE nonwoven fabric.

2. The sealing device according to claim 1, wherein the sealing collar comprises a band of PTFE nonwoven fabric radially rolled about itself.

3. The sealing device according to claim 1, wherein the sealing collar comprises a plurality of superposed disks of the PTFE nonwoven fabric.

4. The sealing device according to claim 1, wherein the sealing collar comprises a nonwoven web of the PTFE nonwoven fabric joined in tubular fashion and rolled up to form a ring.

5. The sealing device according to claim 1, wherein the PTFE nonwoven fabric has a thickness of less than 4 mm.

6. The sealing device according to claim 1, wherein the PTFE nonwoven fabric has a thickness of 0.5 to 2 mm.

7. The sealing device according to claim 1, wherein a PTFE content of the PTFE nonwoven fabric is from 50 to 99 wt.%.

8. The sealing device according to claim 1, wherein a length of the fibers in the PTFE nonwoven fabric is from 3 to 100 mm.

9. The sealing device according to claim 1, wherein a weight per unit area of the nonwoven fabric before PTFE impregnation is from 20 to 800 g/m².

10. The sealing device according to claim 1, wherein fibers of the PTFE nonwoven fabric consist of aramide.

11. The sealing device according to claim 1, wherein the PTFE nonwoven fabric comprises a fiber blend containing at least one selected from the group consisting of glass fibers, aramide fibers, polyamide fibers, polybenzimidazole fibers, basalt fibers, carbon fibers, graphite fibers, and polyester.

12. The sealing device according to claim 1, wherein a plurality of internal surfaces of the sealing collar are inclined relative to each other at an angle from 45 to 120°.

13. The sealing device according to claim 1, wherein a plurality of internal surfaces of the sealing collar are inclined relative to each other at an angle from 60 to 90°.

14. A process for producing a sealing device, comprising:
impregnating a nonwoven fabric with PTFE to form a blank;
drying the blank in a continuous oven at 30 to 300° C.;
compressing the blank in a compression device at a pressure from 5 to 100 MPa to form a V-shaped collar; and
subjecting the V-shaped collar to a sintering treatment at a temperature from 340 to 390° C. for a period of 10 to 60 minutes.

15. The process for producing a sealing device according to claim 14, wherein formation of the blank further comprises radially winding a band of the PTFE nonwoven fabric about itself to form at least two plies.

16. The process for producing a sealing device according to claim 14, wherein the blank comprises at least one annular disk cut out of the PTFE nonwoven fabric or comprises a plurality of superposed annular disks cut out of the PTFE nonwoven fabric.

17. The process for producing a sealing device according to claim 14, wherein formation of the blank further comprises rolling up a web of the PTFE-impregnated nonwoven fabric stitched together to form a tube; and
shaping the tube to form a ring.
